(19) United States
(12) Patent Application Publication
(10) Pub. No.: US 2006/0089276 A1
(43) Pub. Date: Apr. 27, 2006

(54) Coating composition

(76) Inventor: William R Klotz, Milford Square, PA (US)

Correspondence Address: SYNNESTVEDT & LECHNER, LLP, 2600 ARAMARK TOWER, 1101 MARKET STREET, PHILADELPHIA, PA, 191072950, US

(21) Appl. No.: 10/476,686

(22) PCT Filed: May 6, 2002
(86) PCT No.: PCT/US02/14316

§ 371 Date: Dec. 12, 2005

Related U.S. Application Data
(60) Provisional application No. 60/288,617, filed on May 4, 2001.

(51) Int. Cl. C10M 173/02; B32B 27/40

(52) U.S. Cl. 508/464; 508/551; 508/583; 428/423.1

(57) ABSTRACT

A composition which is effective in forming on a substrate a flexible coating that has lubricative properties and which is in the form of an aqueous dispersion having dispersed therein: (a) solid particles of a waxy lubricant; and (b) solid resin particles which are capable of coalescing to form a continuous film in which said solid particles of waxy lubricant are carried; and (c) a water-miscible plasticizer in an amount sufficient to improve the flexibility properties of the coating.

### CROSS-REFERENCE TO RELATED APPLICATION

This application is based on and claims the benefit of prior filed, co-pending provisional Application No. 60/288,617, filed May 4, 2001.

### FIELD OF INVENTION

This invention relates to forming on a substrate a coating having lubricative properties. More particularly, this invention relates to an aqueous coating composition for forming on a substrate a “dry” coating which has lubricative properties and which is flexible.

Both liquid and solid (dry) lubricants are known for reducing the friction between surfaces in contact with each other.

Liquid lubricants such as petroleum-based compositions, vegetable oils, and animal oil-based compositions have drawbacks when used in applications that are not enclosed. They have a tendency to pickup dirt which can be abrasive and damaging to the surface to which they are applied. Also, they must usually be applied at the job site or when parts are being assembled. This can be inefficient and inconvenient.

Dry lubricants have certain advantages relative to liquid lubricants. For example, graphite or molybdenum disulfide powders have been added to various binders to create a film of solid lubricant that can be applied to a part and placed in stock until ready to use. Such films, however, do not always have the flexibility and release properties needed on soft materials such as rubber, cork and other soft materials. Also, such “lubricating” powders are dirty to handle as the graphite or molybdenum disulfide deposits on hands, clothing, etc.

The present invention relates to the provision of a liquid coating composition which is capable of forming a “dry” lubricative coating on a surface.

### REPORTED DEVELOPMENTS

The prior art includes the industrial use of a liquid coating composition which comprises an aqueous dispersion of the following constituents.

| Constituents of Prior Art Composition | wt. % |
|---|---|
| 9-octadecenamide lubricant (Kemamide U fatty amide powder - | 15.7 |
| Witco Chemical, now Crompton Corp.) | |
| aromatic urethane resin binder (Sancure 1511 resin | 23.1 |
| dispersion of B. F. Goodrich) | |
| sodium dodecylbenzene sulfonate surfactant (Nacconol 90G | 5.4 |
| of Stepan Co.) | |
| morpholine dispersant and mold growth inhibitor | 0.2 |
| oleic acid surfactant | 0.1 |
| water | 55.5 |

The above composition is capable of forming on a substrate a dry coating which has lubricating properties and also good adhesive and durability properties. In particular, the above composition is capable of forming on a rigid or flexible substrate a lubricative coating that has adhesive properties such that coated parts can be stacked and or handled without destroying the lubricative properties of the coating prior to incorporating the part into the finished product. This enables the user to avoid the inconvenience of using liquid lubricants and dry lubricants comprising powders that transfer onto whatever comes in contact with the parts. The above-identified composition has been used to form lubricative coatings on gaskets and rubber parts which are typically used in applications in which they are subjected to twisting and rubbing forces. Because of the excellent slip of coatings formed from the composition, it can be used as a mold release agent which does not have to be applied after each use of the mold. Depending on end use, lubricative coatings formed from the above composition can be as thin as about 0.0002″ to about 0.002″.

Although coatings formed from the aforementioned composition have certain desired characteristics, use in industry has revealed that the coatings also have shortcomings. For example, it has been observed that when the coating is exposed to cold temperatures (for example, 50° F. or lower) it becomes brittle, loses adhesion, and flakes off of the substrate. These shortcomings are aggravated when the coating is applied to the surface of a flexible article which is subjected to bending or twisting forces. Also, there is a change from the typical milky-clear color of the coating to a more opaque white color when the coated article is bent.

It has been observed also that if the liquid coating composition is exposed to a cold temperature (below approximately 50° F.), a coating formed therefrom has the same types of defects as when the coating is subjected to cold temperatures. The coating composition can be subjected to such cooler temperatures during shipping and warehousing.

The present invention relates to the provision of an aqueous coating composition that is capable of forming improved flexible, lubricative coatings on various types of substrates, including flexible substrates.

### SUMMARY OF THE INVENTION

In accordance with this invention, there is provided a composition which is effective in forming on a substrate a flexible coating which has lubricative properties and which is in the form of an aqueous dispersion having dispersed therein:
(a) solid particles of a waxy lubricant; and

(B) solid resin particles which are capable of coalescing to form a continuous film in which said solid particles of waxy lubricant are carried;

the improvement wherein said composition includes also a water-miscible plasticizer in an amount sufficient to improve the flexibility properties of the coating.

In preferred form, the composition includes an oleamide fatty amide lubricant, most preferably 9-octadecenamide. Also, in preferred form, the composition includes an alkylene glycol plasticizer, most preferably propylene glycol, and a binder comprising an aromatic urethane resin.

Another aspect of the present invention is the provision of an article having thereon a lubricative coating which is formed from the composition of the present invention. The present invention provides in particular a coated flexible article whose surface has adhered thereto a flexible lubricative coating formed from the composition of the present invention.

Various advantages flow from the use of the present invention. Coatings formed from the composition of the present invention tend to maintain their flexible and lubricative properties and their color even after being subjected to cold temperatures. Furthermore, the exposure of the composition to cold temperatures does not affect adversely their ability to form flexible and cohesive lubricative coatings even when such coatings are present on flexible articles which are subjected to bending and twisting forces. In addition, it has been observed that the use of the plasticizer in the coating composition in accordance with the present invention results in a composition which has improved spray performance. As the liquid composition is sprayed onto the surface of an article, the composition has less of a tendency to run and sag prior to solidifying. This results in the formulation of a smoother coating relative to a composition which does not include the plasticizer.

### DETAILED DESCRIPTION OF THE INVENTION

The aqueous coating composition of the present invention includes dispersed solid particles of a waxy lubricant, dispersed solid resin particles which function as a binder or carrier for the particles of lubricant in the coating, and a water-miscible plasticizer which improves various properties of the coating composition and coatings formed therefrom. Species of each of these constituents are known.

Waxy lubricants are well known materials which are solid materials at room temperature. Any suitable waxy lubricant can be used in the composition of the present invention. Examples of waxy lubricants are animal-based waxes (such as, for example, beeswax, lanolin, shellac wax, and Chinese insect wax), vegetable waxes (such as, for example, carnauba, candelilla, bayberry, sugar cane), mineral fossil or earth waxes such as, for example, ozocerite, ceresin, montan), mineral petroleum waxes (for example, paraffin, microcrystalline, slack or scale wax), ethylenic polymers and polylol ether-esters (such as, for example, poly(ethylene glycols) sold by Union Carbide under the trademark “Carbowax”), chlorinated naphthalenes, hydrocarbon type waxes, and polytetrafluoroethylene (hereafter “PTFE”) waxes and PTFE in admixture with another waxy polymer (hereafter “PTE/polymer mixture”). A mixture of two or more waxy lubricants can be used.

Preferred lubricants are fatty amides, PTFE, and a PTFE/polymer mixture, particularly, a mixture of PTFE and polyethylene copolymer and of PTFE and polyester copolymer. PFTE lubricants are available, for example, from Dyneon under the marks TF-9207, TF-9201, J-16, and J-24. PTFE/polymer mixtures are available, for example, from Lubrizol under the marks Lubrizol's Lanco TF1780 and Lanco 1900 MF. Although PTFE waxes and waxes of a PTFE/polymer mixture are capable of forming coatings having excellent lubricity, the use of fatty amides enables one to form relatively economically coatings which have particularly good lubricity. Examples of fatty amides that can be used in the practice of the present invention include the following: erucamide, arachidamide/behenamide, oleyl palmitamide, stearamide, steryl stearamide, N, N¹-ethylenebisstearamide, N N′-ethylenbisoleamide, oleamide, erucyl stearamide, stearyl erucamide, and oleamide, the last mentioned being particularly preferred. Fatty amides are available commercially, for example, as sold by Crompton Corp., under the trademark Kemamide. Fatty amides can be used as the sole source of the waxy lubricant or in admixture with one or more other lubricants, for example, silicone resin beads or liquid silicone oil, with the fatty amide comprising a major portion of the lubricant component of the composition.

It is known to use oleamides and other fatty amides in greases and liquid lubricants because such amides have a low coefficient of friction. It is known also to use fatty amides in plastic films, for example, polyethylene films by adding the amide to the molten resin from which the film is formed in order to provide slip to the film. Fatty amides having such properties can be used in the practice of the present invention. A highly preferred oleamide for use in the practice of the present invention is 9-octadecenamide.

As mentioned above, waxy lubricants for use in the practice of the present invention are normally solid at room temperature. In preferred form, the nature of the waxy lubricant should be such that a coating formed from a composition of the present invention has a static coefficient of friction of no greater than about 0.3 and a dynamic coefficient of friction of no greater than about 0.3. In particularly preferred form, the static coefficient of friction of the coating should be no greater than about 0.16 and the dynamic coefficient of friction should be no greater than about 0.1. The coefficient of friction (COF) is dependent mainly on the nature of the lubricant and its particle size. The static coefficient of friction is determined according to ASTM D 4518. The dynamic coefficient of friction is determined according to ASTM D 1894. The waxy lubricant is present in the composition of the present invention in a particle size sufficiently small to enable the particles to be dispersed in the aqueous-based composition, preferably uniformly throughout the aqueous phase of the composition. For dispersability, it is preferred that the average particle size of the waxy lubricant be no greater than about 250 microns. Typically, the average particle size of the lubricant will be in the range of about 1 to about 100 microns. A particularly preferred average particle size is about 10 to about 30 microns. Any suitable means can be used to provide such particle sizes, for example, grinding in a pebble mill. It is recommended that a suitable surfactant be used as a dispersing agent to aid in dispersing the particles of lubricant in the aqueous phase of the composition. Such dispersing agents are well known.

The waxy lubricant should be present in the composition in an amount such that the desired lubricative properties of the coating formed from the composition are achieved. The lubricative properties of the coating will vary from one application to the next and so the amount of lubricant will need to be adjusted accordingly. It is believed that, for most applications, the amount of lubricant will comprise a minor amount of the coating composition (that is, less than about 50 wt. % based on the total weight of the composition). It is believed that typical amounts of lubricant will comprise about 10 to about 25 wt. % of the composition.

The composition of the present invention includes also a material which functions to form a continuous film (coating) on the substrate to which it is applied and which functions also as a carrier or binder for the lubricant. The material should be such that it is capable of forming a coating that has the desired flexibility. It is noted that various properties of a material are related to the flexibility of the material, particularly the glass transition temperature (Tg), tensile strength, elastic modulus, and percent elongation of the material. Accordingly, materials which are flexible can be identified by a recognition of such properties. Materials which are readily available for forming flexible coatings are resins, including preferably those supplied in the form of a latex, that is, an aqueous dispersion of solid resin particles. Examples of resins which are suitable for use in the composition of the present invention are acrylic, epoxy, urethane, phenolic, alkyd, vinyl, vinyl acetate, acetate esters, and silicones. The resin can be a thermoset or thermoplastic resin.

A preferred resin for us in the composition of the present invention comprises an aromatic urethane resin, species of which are available commercially. Such a resin is available as a fully reacted urethane polymer in the form of a colloidal dispersion in water (a latex). Coatings formed from the resin are fast drying, easily crosslinkable, and have good abrasion-resistance. A coating formed from a composition containing the resin has excellent adhesion to a variety of substrates along with a balance of hardness and flexibility that makes it a preferred resin for use in the practice of this invention. Various characteristics of a species of a water-dispersed urethane resin composition (Sancure® 1511—B.F. Goodrich) that is available commercially are set forth below.

| | |
|---|---|
| pH | 9.0 |
| particle charge | anionic |
| 100% Modulus | 3140 psi |
| tensile strength | 5500 psi |
| elongation | 250% |
| gloss (60°) | 95 |
| sward hardness | 56 |
| flash point | none |

The above composition includes also 1-methyl-2-pyrrolidinone which functions as a solubilizer for the resin constituent.

The resin constituent is present in the composition in an amount sufficient to form a continuous coating on the substrate and to function as carrier or binder for the lubricant. It is believed that, for most applications, the resin particles will comprise about 5 to about 20 wt. % of the composition.

The composition of the present invention includes also a material which imparts plasticizing effects to coatings formed from the composition and aids in maintaining the coating-forming abilities of the composition when it is subjected to relatively low temperatures. Any suitable water-miscible plasticizer can be used in the composition. Examples of plasticizers are glycerol, ethylene glycol, propylene carbonate, glycerides, sorbitols, saccharides, or other materials which increase elongation or decrease modulus or Tg of the composition. A preferred plasticizer is propylene glycol which, in addition to its plasticizing properties, functions also as a freezing point depressant.

The plasticizer is included in the composition in an amount sufficient to improve the coating in respect of its flexibility, particularly as regards the flexibility of the coating when subjected to relatively low temperatures. Relatively small amounts of the plasticizer can be used to accomplish this, for example, about 0.1 to about 5 wt. %, preferably about 1 to about 3 wt. %.

In preferred form, the composition of the present invention should have a viscosity which is sufficiently high to maintain uniformly dispersed in the composition solid particles of the waxy lubricant and to enable the composition to be applied to a vertical surface in a sufficiently thick amount to form a coating of the desired thickness. A composition which has a viscosity of at least 50 cps, more preferably at least 1000 cps, is preferred (as evaluated by Brookfield RV with No. 1 Spindle). The upper limit on the viscosity of the composition is such that the composition is the form of a flowable liquid. As may be necessary to formulate a composition with the desired viscosity, a thickening agent can be included in the composition. Any thickening agent which is compatible with the other constituents of the composition can be used. The thickening agent can function simply to thicken the composition or it can function to impart also thixotropic properties to the composition. In the case of using a solid thickening agent, it can be a material which is water-insoluble or a material that is slightly soluble to highly soluble in water. Examples of thickening agents are clays (such as, for example, montmorillonite clay minerals), silicas (such as, for example, fumed silica and colloidal silica), cellulosics (such as, for example, hydroxyethyl cellulose and carboxymethyl cellulose), acrylics (such as, for example, acrylate alkali-swellable emulsions), and urethanes (such as, for example, a hydrophobically-modified ethoxylated urethane alkali-swellable emulsion which is a preferred thickening agent).

The amount of thickening agent needed to impart to the composition the desired viscosity will depend on various factors, including, for example, the viscosity of the composition without the thickening agent and the nature of the various constituents which comprise the composition. Typically, a relatively small amount of thickening agent will be needed, for example, about 0.1 to about 5 wt. % or more typically an amount of about 1 to about 3 wt. % based on the total weight of the composition.

Various additives can be included in the composition in amounts effective to achieve the desired effects of the additives. Exemplary additives are defoamers, fungicides, for example, mildew growth inhibitors, surfactants, for example, dispersing agents, protective colloids, and coalescing agents. Such materials are well known in the art.

The composition of the present invention can be prepared in any suitable way. It has been observed that a lubricant such as 9-octadecenamide is difficult to disperse in water even when using high speed, high shear mixes. Accordingly, it is recommended that an aqueous dispersion of this type of lubricant be prepared and then mixed with the aqueous dispersion of resin particles. It is recommended also that the aqueous dispersion of lubricant include a suitable surfactant(s) for dispersing the particles thereof and that mixing be effected in a pebble mill for a suitable period of time, for example, about 8 to about 12 hours.

The coating composition of the present invention can be used to form lubricating coatings on any suitable surface including, for example, rigid and flexible surfaces, and heat-sensitive surfaces. Examples of materials comprising such surfaces are plastic, rubber, cork, and metallic surfaces. It is believed that the present invention will be used widely to form flexible, lubricative coatings on flexible articles such as, for example, rubber gaskets, o-rings, mating rubber surfaces, molds, rubber auto parts, hoses, and bushings. Such flexible articles are generally characterized by having the following properties: elongation of about 200 to about 400%; shore D hardness of about 20 to about 30; 100% modulus of about 400 psi to about 600 psi; and tensile strength of about 1500 to about 2500 psi. The standard test procedure used to evaluate tensile strength, elongation, and modulus is ASTM D 2370 and the test method for Shore hardness of the substrate is ASTM D 2240.

The coating composition can be applied to the surface of the article in any suitable way, for example, by spraying, brushing, rolling, curtain coating and flood coating, dip coating, and fogging. The amount of composition applied to the surface will depend on the thickness of the coating to be formed on the article. The thickness of the coating depends on the application in which the coated article is to be used. An exemplary coating thickness is in the range of about 0.0002 to about 0.002 inch.

After the liquid coating composition is applied to the substrate, the composition should be allowed to form a continuous coating or film comprising the resin as the water constituent evaporates or, in the case of a porous substrate, is absorbed into the substrate. The formation of the continuous resin coating can take place at room temperatures or at elevated temperatures (for example, about 130 to about 250° F.) depending upon the nature of the resin. As mentioned above, a composition of the present invention can be used to form a coating which itself is flexible, as characterized by the coating having the following properties: elongation of about 50 to about 250%; 100% modulus of about 150 to about 300 psi; and tensile strength of about 200 to about 400 psi.

### EXAMPLES

The following is an example of a coating composition of the present invention.

### Example No. 1

| Constituents | wt. % |
|---|---|
| 9-octadecenamide lubricant (Kemamide U fatty amide powder - | 15.38 |
| Witco Chemical, now Crompton Corp.), average particle size | |
| about 40 microns, static COF - 0.29, dynamic COF - 0.28 | |
| aromatic urethane resin binder (Sancure 1511 resin | 7.91 |
| dispersion of B. F. Goodrich) | |
| propylene glycol | 1.94 |
| 1-methyl-2-pyrrolidinone (M-Pyrol) | 2.49 |
| sodium dodecylbenzene sulfonate surfactant (Nacconol 90G | 1.32 |
| of Stepan Co.) | |
| morpholine dispersant and mold growth inhibitor | 0.2 |
| oleic acid surfactant | 0.07 |
| silicone defoamer (Decfo XQC-136B of Ultra Additives) | 0.004 |
| water | 70.686 |

### Example No. 2 and Comparative Example

One gram of propylene glycol is added to 50 grams of the prior art composition described hereinabove to form a composition (Example No. 2) of the present invention. Each of the compositions was subjected to two freeze-thaw cycles, one cycle consisting of 16 hours in a freezer followed by removal to a room temperature environment to allow a complete thaw. A coating formed from the prior art composition flaked very badly after application to a flexible rubber substrate and was discolored. On the other hand, a coating formed from the composition of Example No. 2—propylene/glycol-containing composition—does not exhibit flaking or discoloring.

Tests were also conducted to determine the effect of cold on coatings formed from the above prior art composition and the composition of Example No. 2. Neither composition is exposed to cold temperatures prior to application. Coatings formed therefrom have satisfactory properties. On the other hand, the coated articles are then evaluated in a cold environment. The coating formed from the prior art composition failed in that it turned white and flaked off. In contrast, coatings formed from the propylene/glycol-containing composition of Example No. 2 passes with 100% successful results.

It is believed that the propylene glycol (and other plasticizers) have a plasticizing effect on the coating such that it holds the coating together and keeps the coating flexible when exposed to cold temperatures.

The following compositions are examples of additional embodiments of the present invention. Each of the following compositions contains the same constituents and amounts as is present in the composition of Example No. 1 except that the lubricant of the composition of Example No. 1 is the lubricant identified in Table 1 below. Each of the compositions of Table 1 was used to form a coating having a thickness of about 1 mil on an EPDM rubber substrate. The composition was applied by air-atomizing spray. The COFs of the coatings were evaluated, as reported in Table 1.

TABLE 1

| | | Lubricant | | | | |
|---|---|---|---|---|---|---|
| | | | Average | Coating | | |
| Ex. | | M.P. | Particle Size | Coefficient of Friction | | Specific |
| No. | Lubricant | ° F. | Microns | Static | Dynamic | Gravity |
| 3 | 9-octadecenamide | 172 | between | 0.159 | 0.091 | — |
| | (oleamide, Kemamide U) | | 10 & 30 | | | |
| 4 | 13-docosenamide | 186 | — | 0.129 | 0.107 | 0.815 |
| | (erucamide, Kemamide E) | | | | | |
| 5 | docosanamide | 226 | — | 0.133 | 0.087 | 0.807 |
| | (Kemamide B) | | | | | |
| 6 | hexadecanamide, | 159 | — | 0.141 | 0.12 | 0.794 |
| | N-9-octadecenyl- | | | | | |
| | (oleyl palmitamide, | | | | | |
| | Kemamide P181) | | | | | |
| 7 | octadecanamide | 217 | — | 0.144 | 0.137 | 0.809 |
| | (stearamide, Kemamide S) | | | | | |
| 8 | octadecanamide, N-octadecyl- | 200 | — | 0.144 | 0.082 | 0.783 |
| | (stearyl steramide, | | | | | |
| | Kemamide S-180) | | | | | |
| 9 | N, N¹ ethylenebisstearmide | 284 | — | 0.145 | 0.102 | — |
| | (Kemamide W-40) | | | | | |
| 10 | N, N¹ ethylenebisoleamide | 248 | — | 0.157 | 0.145 | 0.775 |
| | (Kemamide W-20) | | | | | |
| 11 | erucylstearamide | 172 | — | 0.161 | 0.148 | — |
| | (Kemamide S-221) | | | | | |
| 12 | 13-docosenamide, N-octadecyl- | 164 | — | 0.175 | 0.157 | 0.79 |
| | (stearyl erucamide, | | | | | |
| | Kemamide E-180) | | | | | |
| 13 | polyol ester/PTFE | 140 | — | 0.175 | 0.128 | 1.06 |
| | (Lanco 1900 MF) | | | | | |
| 14 | amorphous amide wax | 367 | — | 0.182 | 0.137 | 0.99 |
| | (Lanco HM 1666) | | | | | |
| 15 | long chain amorphus amide wax | 284 | — | 0.218 | 0.216 | 1 |
| | (Lanco D2S) | | | | | |
| 16 | polytetrafluoroethylene (J-16) | — | 6 | 0.096 | 0.09 | — |
| 17 | polyethylene/PTFE | 216 | — | 0.169 | 0.152 | 0.98 |
| | (Lanco TF 1780) | | | | | |

With respect to Example No. 16 above, it is noted that the composition of this example was thickened with twenty drops of Polyphobe 116, which is a hydrophobically-modified ethoxylated urethane alkali-swellable emulsion. As mentioned above, a thickening agent can be added to the composition to impart to it desired viscosity for effective use in applying the coating composition to a substrate, for example, applying the coating composition to a vertical substrate.

1. In a composition which is effective in forming on a substrate a flexible coating which has lubricative properties and which is in the form of an aqueous dispersion having dispersed therein:
(a) solid particles of a waxy lubricant; and
(b) solid resin particles which are capable of coalescing to form a continuous film in which said solid particles of waxy lubricant are carried;
the improvement wherein said composition includes also a water-miscible plasticizer in an amount sufficient to improve the flexibility properties of the coating.

2. A composition according to claim 1 wherein said composition includes also a dispersing agent for the particles of lubricant and the resin particles.

3. A composition according to claim 1 comprising 9-octadecenamide, an aromatic urethane resin, and propylene glycol.

4. An article having a surface which has thereon a coating formed from the composition of claim 1.
